(19) United States
(12) Patent Application Publication
(10) Pub. No.: US 2013/0006482 A1
(43) Pub. Date: Jan. 3, 2013

(54) GUIDANCE SYSTEM FOR A MOBILE MACHINE

(76) Inventors: Ramadev Burigsay Hukkeri, Pittsburgh, PA (US); Eric Alan Reiners, Washington, IL (US)

(21) Appl. No.: 13/173,675

(22) Filed: Jun. 30, 2011

(51) Int. Cl. G06F 7/00; G01D 21/00

(52) U.S. Cl. 701/50; 73/146

(57) ABSTRACT

A method is disclosed for determining a grade of a roadway bordered by a marker including a bottom that contacts the roadway, with a machine traveling on the roadway. A scanning device mounted on the machine is used to locate a first point indicative of the bottom of the marker at a first geographical location along the roadway. The scanning device is also used to locate a second point indicative of the bottom of the marker at a second geographical location along the roadway. The locations of the first and second points are compared to determine the grade of the roadway. Also disclosed is a method for determining a bank of a roadway bordered on a first side by a first marker including a bottom that contacts the roadway and bordered on a second side by a second marker including a bottom that contacts the roadway, with a machine traveling on the roadway. A first scanning device mounted on one of a left side and a right side of the machine may be used to locate a first point indicative of the bottom of the first marker at a geographical location along the roadway. A second scanning device mounted on the other side of the machine may be used to locate a second point indicative of the bottom of the second marker at the same geographical location. The locations of the first and second points may be compared to determine the bank of the roadway.

### TECHNICAL FIELD

The present disclosure relates generally to a guidance system and, more particularly, to a guidance system for a mobile machine.

### BACKGROUND

Machines such as, for example, off-highway haul trucks, motor graders, snow plows, and other types of heavy equipment are used to perform a variety of tasks. Some of these tasks involve carrying or pushing large, awkward, loose, and/or heavy loads up steep inclines or along rough or poorly marked haul roads. And, because of the size and momentum of the machines and/or because of poor visibility, these tasks can be difficult for a human operator to complete effectively.

To help guide the machines along the haul roads and keep the machines within appropriate lanes on the haul roads, some worksites utilize earthen berms located at the sides of the haul roads. The berms act as borders of the haul road, providing a visual indication of the edge of the road and functioning to either redirect the machine back onto the road or hinder further movement off of the road, should the machine deviate from an appropriate lane. Although effective, the use of the earthen berms alone may be insufficient to keep some large or heavily loaded machines on the haul roads and, in some situations, may damage the machines when the machines contact the berms. As such, an alternative or additional method for keeping the machines within the appropriate lanes of a haul road, and for keeping the machines from contacting the berms, may be necessary.

It is known to equip such a machine with one or more specialized sensors to determine the grade of the haul road (i.e., a difference in elevation generally parallel to a direction of travel of the machine along the haul road) and the bank of the haul road (i.e., a difference in elevation generally perpendicular to the direction of travel of the machine on the haul road). These sensors directly sense the grade and the bank of the haul road underneath and/or in front of the machine. Once the grade and the bank of the haul road are known, the speed at which the machine travels on the haul road may be adjusted. For example, if the sensors determine that the haul road is fairly level, it may be possible to safely increase the speed of the machines while remaining fairly confident that the machine will not contact the berm. Conversely, if the sensors indicate the haul road is very steep, the speed of the machine may need to be reduced to reduce the risk that the machine will slide and contact the berm.

The use of these specialized sensors, however, results in numerous disadvantages. For example, the sensors may sense a relatively small area of the haul road and, therefore, the sensed grade and bank may not accurately reflect the actual grade and bank of the haul road. Moreover, because the machine requires specialized sensors to sense the grade and the bank of the haul road, in addition to the other sensors used with the machine, there are additional expenses and complexities associated with such systems.

The disclosed guidance system is directed to overcoming one or more of the problems set forth above and/or other problems of the prior art.

### SUMMARY

The disclosure provides a method of determining a grade of a roadway bordered by a marker including a bottom that contacts the roadway, with a machine traveling on the roadway. In the method, a scanning device mounted on the machine may be used to locate a first point indicative of the bottom of the marker at a first geographical location along the roadway. The scanning device may also be used to locate a second point indicative of the bottom of the marker at a second geographical location along the roadway. The locations of the first point and the second point may be compared to determine the grade of the roadway.

The disclosure further provides a method for determining a bank of a roadway bordered on a first side by a first marker including a bottom that contacts the roadway and bordered on a second side by a second marker including a bottom that contacts the roadway, with a machine traveling on the roadway. A first scanning device mounted on one of a left side and a right side of the machine may be used to locate a first point indicative of the bottom of the first marker at a geographical location along the roadway. A second scanning device mounted on the other one of the right side and the left side of the machine may be used to locate a second point indicative of the bottom of the second marker at the same geographical location. The locations of the first point and the second point may be compared to determine the bank of the roadway.

The disclosure still further provides a method for controlling travel of a machine on a roadway bordered by an earthen berm including a bottom that contacts the roadway. At least one of a grade and a bank of the roadway may be determined by sensing the bottom of the earthen berm with at least one sensing device mounted on the machine, where the grade is measured generally parallel to a direction of travel of the machine on the roadway and the bank is measured generally perpendicular to the direction of travel. A controller may determine a maximum speed for the machine to travel on the roadway based on the determined grade or bank of the roadway. The controller may compare an actual speed at which the machine is traveling on the roadway with the determined maximum speed. The controller may output a signal that suggests or causes a change in operation of the machine based on the comparison.

### BRIEF DESCRIPTION OF THE DRAWINGS

FIG. 1 is a pictorial illustration of an exemplary disclosed machine; and

FIG. 2 is a flowchart depicting an exemplary disclosed method associated with operation of the machine of FIG. 1.

### DETAILED DESCRIPTION

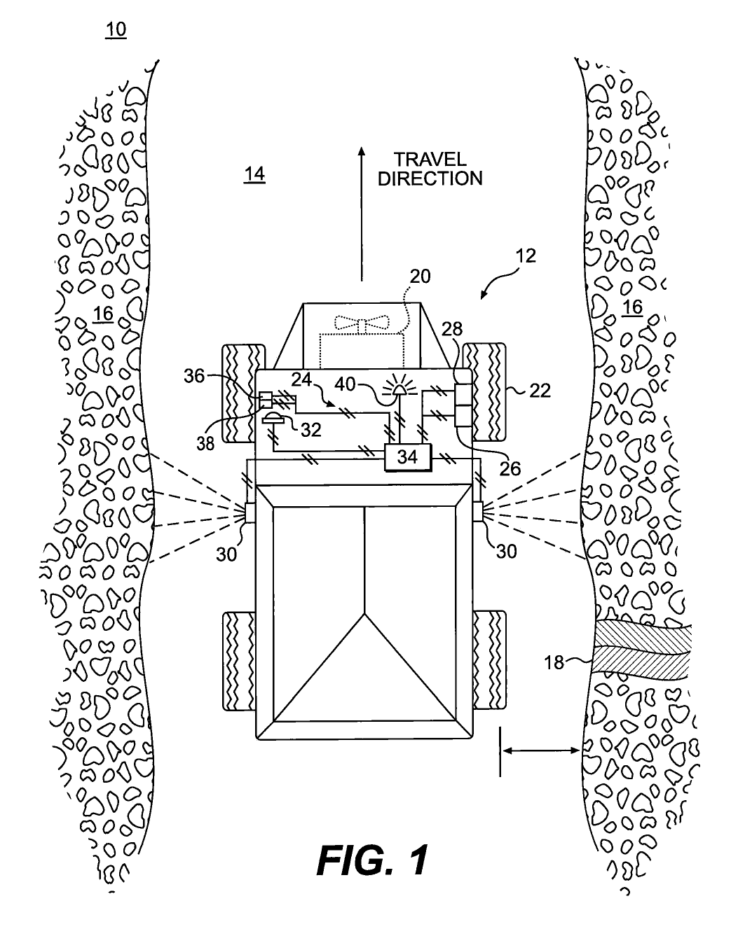

FIG. 1 illustrates a worksite 10 and an exemplary machine 12 performing a task at worksite 10. Worksite 10 may include, for example, a mine site, a landfill, a quarry, a construction site, or any other type of worksite having a roadway 14 traversable by machine 12. Roadway 14 may be bordered on each side by a marker 16, for example an earthen berm. In addition to marking a border of roadway 14, each earthen berm may also provide a barrier to machine 12 that inhibits machine 12 from leaving roadway 14 and/or redirects machine 12 toward a center of roadway 14 in the event that machine 12 contacts the earthen berm. Distances along roadway 14 may be marked such that, by monitoring the marked distances traveled by machine 12 along roadway 14 from a fixed starting point, a geographical location of machine 12 may be determined. In one example, the distances may be marked by a break 18 in the marker 16. It is contemplated, however, that other ways to mark the distances along roadway 14 may be utilized. Although shown in FIG. 1 as a single lane roadway, it is contemplated that roadway 14 may alternatively include multiple lanes, if desired.

The task being performed by machine 12 may be associated with altering the geography at worksite 10 and may include, for example, a hauling operation, a grading operation, a leveling operation, a plowing operation, a bulk material removal operation, or any other type of operation. As such, machine 12 may embody a mobile machine, for example a haul truck, a motor grader, a loader, or a snow plow. Machine 12 may include, among other things, a power source 20, one or more traction devices 22, and a guidance system 24. Power source 20 may generate and provide power to traction devices 22, while guidance system 24 may regulate operation of traction devices 22 and/or power source 20 in response to various inputs.

Power source 20 may embody an internal combustion engine such as, for example, a diesel engine, a gasoline engine, a gaseous fuel powered engine, or any other type of engine apparent to one skilled in the art. Power source 20 may alternatively or additionally include a non-combustion source of power such as a fuel cell, a power storage device, an electric motor, or other similar mechanism. Power source 20 may be connected to drive traction devices 22 via a direct mechanical coupling, a hydraulic circuit, an electrical circuit, or in any other suitable manner.

Traction device 22 may be a wheel, a belt, a track, or any other driven traction device known in the art. Traction device 22 may be driven by power source 20 to rotate and propel machine 12 in accordance with an output rotation of power source 20. A steering device 26, for example a hydraulic cylinder, a hydraulic motor, an electric motor, and/or a rack-and-pinion configuration may be associated with one or more traction device 22 to affect steering thereof. In addition, a braking device 28, for example a compression disk brake, an internal fluid brake, an engine retarder, an exhaust brake, and/or a transmission brake may be associated with one or more traction device 22 and/or power source 20 to affect braking of machine 12.

Guidance system 24 may include multiple components that interact to regulate and/or sense maneuvering of machine 12. Specifically, guidance system 24 may include one or more scanning devices 30, a locating device 32, and a controller 34 in communication with one or more scanning devices 30, locating device 32, steering device 26, and braking device 28. Controller 34 may be configured to control maneuvering (i.e., steering and/or braking) of machine 12 based on input received from scanning devices 30, locating device 32, and/or an operator of machine 12. Guidance system 24 may also include a speed sensor 36 configured to sense an actual speed of travel of machine 12, and a steering angle sensor 38 configured to sense an actual steering angle of machine 12, both of which may also be in communication with controller 34. Specifically, controller 34 may be configured to receive outputs from speed sensor 36 and steering angle sensor 38.

Scanning device 30 may be attached to a side of machine 12 to sense an actual lateral distance from machine 12 to marker 16 (i.e., a distance generally orthogonal to a travel direction of machine 12) and to generate a distance signal in response thereto. In accordance with one exemplary embodiment, machine 12 may include two scanning devices 30; one scanning device on each of the left side and the right side of machine 12. Each scanning device 30 may embody a device that detects and ranges objects, for example a LIDAR (light detection and ranging) device, a RADAR (radio detection and ranging) device, a SONAR (sound navigation and ranging) device, or another device known in the art. In one example, scanning device 30 may include a plurality of emitters that emit detection beams, as well as one or more receivers that receive reflections of the detection beams. Based on characteristics of the received beams, an actual lateral distance from machine 12 to marker 16 may be determined. Scanning device 30 may then generate a distance signal corresponding to the actual lateral distance, and communicate the distance signal to controller 34. Based on an interruption of the distance signal corresponding to break 18, a location with respect to a known starting point may be determined (i.e., the geographical location of machine 12 may be determined by measuring distance(s) and direction(s) traveled relative to break 18, when break 18 has a known geographic location).

Alternatively or additionally, locating device 32 may be used to determine the geographical location of machine 12. In particular, locating device 32 may embody an electronic receiver configured to communicate with one or more satellites (e.g., a global positioning system) or a local radio or laser transmitting system to determine a relative location of itself. In some embodiments, locating device 32 may receive and analyze high-frequency, low power radio or laser signals from multiple locations to triangulate a relative 3-D location. Alternatively, locating device 32 may embody an Inertial Reference Unit (IRU), an odometer associated with traction device 22, or any other known locating device operable to receive or determine locational information associated with machine 12. A location signal indicative of this location may then be communicated from locating device 32 to controller 34.

Controller 34 may include means for monitoring, recording, storing, indexing, processing, and/or communicating the lateral distance between machine 12 and marker 16 as well as the geographical location of machine 12, and for autonomously controlling maneuvering of machine 12 in response to this information. These means may include, for example, a memory, one or more data-storage devices, a central processing unit, or any other components that may be used to run the disclosed application. Furthermore, although aspects of the present disclosure may be described generally as being stored within memory, one skilled in the art will appreciate that these aspects can be stored on or read from different types of tangible, non-transitory computer program products or tangible, non-transitory computer-readable media such as computer chips and secondary storage devices, including hard disks, floppy disks, optical media, CD-ROM, or other forms of RAM or ROM.

Controller 34 may be configured to compare a desired lateral distance between machine 12 and marker 16 with the actual lateral distance provided by scanning device 30, and respond according to this comparison. Specifically, based on a difference between the desired lateral distance and the actual lateral distance (e.g., based on an error value calculated as a function of this difference), controller 34 may respond in a number of different ways. For example, if the actual lateral distance is about equal to or greater than the desired lateral distance, controller 34 may not respond at all. However, if the actual lateral distance is less than the desired lateral distance by a threshold amount, controller 34 may warn an operator of machine 12 of imminent danger or recommend action by the operator, autonomously control steering device 26 to increase the actual lateral distance, and/or autonomously control braking device 28 to slow or even stop travel of machine 12 toward marker 16. The warning or recommendation may be audible, visual, or a combination of both audible and visual stimulation. For this purpose, an indicating device 40 may be included within an operator station of machine 12. In one example, controller 34 may also display within the operator station a position of machine 12 relative to marker 16, if desired.

In one embodiment, the desired lateral distance may be received from an operator of machine 12. That is, each operator may have a personal preference for the distance that should be maintained between machine 12 and marker 16. As such, controller 34 may allow the operator to input and/or adjust the desired lateral distance at startup of machine 12 and/or during operation thereof. This input may be received by way of an operator interface device (not shown) located within the operator station of machine 12. In one embodiment, the operator interface device may be a keyboard, a mouse, a touch screen display, a laptop computer, or other similar device.

Alternatively or additionally, the desired lateral distance may be set or vary based on a likelihood of machine 12 contacting or crossing marker 16. Specifically, if the likelihood of machine 12 contacting or crossing marker 16 is high, the desired lateral distance may be increased. Similarly, if the likelihood of machine 12 contacting or crossing marker 16 is low, the desired lateral distance may be decreased. The likelihood of machine 12 contacting or crossing marker 16 may be affected by a roadway condition, an environmental condition, a machine condition, an operator condition, and or other similar conditions. For example, a rough roadway having a loose or slick surface may decrease a stability of machine 12, thereby increasing the likelihood of machine 12 veering off course into contact with marker 16. Similarly, a heavily loaded, older haul truck traveling at high speed may have less stability, reduced stopping power, and/or reduced steering than a lightly loaded newer motor grader traveling at a slower speed. Thus, the haul truck may have a greater likelihood of contacting or crossing marker 16 than the motor grader and subsequently require that a greater lateral distance from marker 16 be maintained. Further, an operator having less experience and/or a lower skill level may require more response time than an experienced operator and, thus, a greater lateral distance should be maintained between machine 12 and marker 16 for a new operator.

Similarly, the desired lateral distance may be set or vary based on a potential severity associated with machine 12 contacting or crossing marker 16. This potential severity can change based on a financial value of machine 12 and/or an amount of damage that could be caused by machine 12 leaving roadway 14. For example, if the geographical location of machine 12 provided by locating device 32 corresponds with an edge of cliff, leaving roadway 14 could have significant consequences (i.e., the severity associated with machine 12 leaving roadway 14 at this location could be high). In contrast, if the geographical location of machine 12 corresponds with flat level terrain, leaving roadway 14 may have minor consequences (i.e., the severity associated with machine 12 leaving roadway 14 at this location could be low). For this purpose, controller 34 may relate locational information from locating device 32 to local terrain and, subsequently, to the potential severity involved with machine 12 leaving roadway 14 at a particular geographical location.

Controller 34 may be configured to receive risk information (i.e., roadway condition information, environmental condition information, machine condition information, operator condition information, geographical location information, and other information associated with the likelihood of machine 12 leaving roadway 14 and/or the severity of doing so) at startup of machine 12, on a periodic basis, and/or continuously by way of the operator interface device, location device 32, geographical maps contained within the memory of controller 34, an offboard system (not shown), and/or in other ways. It is also contemplated that some or all of this information may be monitored by way of onboard sensors, if desired. For example, machine loading information may be provided by way of one or more load cells (not shown), roadway conditions and environmental conditions may be provided by way of a traction device slip sensor (not shown), operator conditions may be provided by way of an operator identity sensor (not shown), machine conditions may be provided by way of speed sensor 36 or an hour meter, etc. Based on this received information, controller 34 may be configured to adjust the desired lateral distance to reduce the likelihood of machine 12 leaving roadway 14 and/or the severity of doing so (i.e., to change the desired lateral distance and/or machine travel speed based on the perceived risk level).

In addition, controller 34 may be configured to respond differently to the comparison of the desired lateral and actual lateral distances based on the perceived risk level. For example, if the risk level is perceived to be low, controller 34 may only warn the operator of machine 12 about the lateral distance difference. In contrast, if the risk level is perceived to be high, controller 34 may warn the operator, affect steering, and/or affect braking of traction devices 22 in response to the same lateral distance difference. The way that controller 34 responds to the lateral distance difference may be provided to controller 34 at manufacture of machine 12 and/or adjusted by operator instruction.

Scanning device 30 may also be used to compare actual locations of a bottom of marker 16 (e.g., locations where marker 16 meets roadway 14) at multiple geographical locations along roadway 14 to determine a grade of roadway 14 (i.e., a difference in elevation generally parallel to a direction of travel of machine 12 on roadway 14). In one example, the plurality of emitters of scanning device 30 may be aligned in a generally vertical direction when machine 12 is on a level surface, so that scanning device 30 emits a plurality of detecting beams capable of intersecting marker 16 and roadway 14 at different locations and elevations. The one or more receivers of scanning device 30 may receive reflections of the detecting beams. Information regarding the emitted and received beams may be output by scanning device 30 to controller 34. Scanning device 30 may be rotated, so that controller 34 receives information regarding another geographical location along roadway 14. Alternatively, scanning device 30 may substantially simultaneously (i.e., at about the same time) or consecutively (i.e., at different times) scan multiple geographical locations along roadway 14 without movement of scanning device 30. For example, scanning device 30 may have multiple rows of emitters, each row including a plurality of emitters aligned in a generally vertical direction when machine 12 is on a level surface, with the rows spaced apart in a generally horizontal direction, and one or more corresponding receivers.

Controller 34 may analyze characteristics of the received beams and/or otherwise compare the received beams with the emitted beams, and determine the actual location of the bottom of marker 16 for the corresponding geographical location along roadway 14. For example, for a particular geographical location along roadway 14, controller 34 may analyze the received beams to determine actual locations of objects that are either marker 16 or roadway 14. Specifically, controller 34 may analyze data points defined by the received beams, and based on characteristics of the data points, may separate the data points into first and second groups of consecutive points, the first and second groups representing marker 16 and roadway 14, respectively. An analysis may be performed on the first group of consecutive points defined by the received beams. Controller 34 may define a first curve, which may be a generally straight line, that “best-fits” these points. Similarly, an analysis may be performed on the second group of consecutive points defined by the received beams. Controller 34 may define a second curve, which may be a generally straight line, that “best-fits” these points. An intersection point of the first and second curves may be used to define the actual location of the bottom of marker 16 for that geographical location along roadway 14. Similarly, the actual location of the bottom of marker 16 may be determined for one or more other geographical locations along roadway 14. In accordance with the disclosure, a comparison of at least two consecutive actual locations of the bottom of marker 16 may be used to determine the grade for the portion of roadway 14 extending between the geographical locations that were scanned by scanning device 30.

As stated above, one scanning device 30 may be disposed on the left side of machine 12, and another scanning device 30 may be disposed on the right side of machine 12. Thus, in accordance with the above discussion, the grade of roadway 14 may be determined for the left side of machine 12 using one scanning device 30, and the grade of roadway 14 may be determined for the right side of machine 12 using the other scanning device 30. The grades of the left and right sides of roadway 14 may differ from one another. In these situations, the left side grade and the right side grade may be averaged, for example, to determine a single value for the grade of the portion of roadway 14 extending between the two geographical locations.

As discussed above, machine 12 may determine its position on roadway 14, either as a result of measuring its direction and position relative to break 18 (which has a known geographical location) or through the use of locating device 32. Controller 34 may include means for monitoring, recording, storing, indexing, processing, and/or communicating the grade of roadway 14 and the geographical location of machine 12. This means may be the same as the means for monitoring, recording, storing, indexing, processing, and/or communicating the lateral distance between machine 12 and marker 16. Controller 34 may also use the same means, or a different means, for autonomously controlling maneuvering of machine 12 in response to this information regarding the grade of roadway 14.

Specifically, controller 34 may store one or more grade maps (discussed below), each grade map storing maximum permissible or recommended speeds as a function of road grades. Controller 34 may use the grade map to identify the maximum permissible or recommended speeds of machine 12. Controller 34 may also compare the actual speed at which machine 12 is traveling down roadway 14, such as by output from speed sensor 36, to a maximum permissible speed of machine 12 on roadway 14 from the grade map. Based on a result of this comparison, controller 34 may respond in a number of different ways. For example, if the actual speed of machine 12 is about equal to the maximum permissible speed, controller 34 may not respond at all. However, if the actual speed of machine 12 is greater than the maximum permissible speed by a first threshold amount, controller 34 may warn the operator of machine 12 of imminent danger or recommend action by the operator, and/or autonomously control braking device 28 to slow or even stop travel of machine 12 on roadway 14. The warning or recommendation may be audible, visual, or a combination of both audible and visual stimulation. For this purpose, indicating device 40 may be used. Further, if the actual speed of machine 12 is less than the maximum permissible speed by a second threshold amount, controller 34 may recommend to the operator that the speed of machine 12 be increased, or controller 34 may increase the speed of machine 12. This recommendation also may be audible, visual, or a combination of both, and indicating device 40 may be used. The second threshold amount may be the same as or different than the first threshold amount.

The one or more grade maps stored by controller 34 may include a number of different grade maps storing maximum permissible speeds as a function of road grades. The particular grade map used by controller 34 may be selected based on a variety of factors, including one or more of a roadway condition, an environmental condition, a machine condition, an operator condition, and or other similar conditions. For example, when roadway 14 is rough, or has a loose or slick surface, or when machine 12 is older, heavily loaded, or is driven by an operator having less experience and/or a lower skill level, a grade map with relatively lower maximum permissible speeds may be selected. Similarly, the grade map used by controller 34 may be selected based on a potential severity associated with machine 12 contacting or crossing marker 16. For example, when a financial value of machine 12, or an amount of damage that could be caused by machine 12 leaving roadway 14, is relatively high, a grade map with relatively lower maximum permissible speeds may be selected. These factors may be set as a result of outputs of various sensors, or may be set by the operator, as discussed above. Alternatively, the operator may select the grade map.

Optionally or in addition to the use of scanning devices 30 to determine the grade of roadway 14, scanning devices 30 may be used to compare the actual locations of the bottoms of markers 16 on opposite sides (i.e., left and right sides) of machine 12 at a same geographical location to determine a bank of roadway 14 (i.e., a difference in elevation generally perpendicular to the direction of travel of machine 12 on roadway 14). In one example, each of the left and right sides of machine 12 may include scanning device 30, and each scanning device 30 may include the plurality of emitters aligned in a generally vertical direction when machine 12 is on a level surface, so that scanning device 30 emits the plurality of detecting beams capable of intersecting marker 16 and roadway 14 at different locations and elevations. The one or more receivers of scanning device 30 may receive reflections of the detecting beams. Information regarding the emitted and received beams may be output by each scanning device 30 to controller 34.

Controller 34 may analyze characteristics of the received beams and/or otherwise compare the received beams with the emitted beams, and determine the actual locations of the bottoms of markers 16 for opposite sides of machine 12 at the same or generally the same geographical location along roadway 14. For example, for a particular geographical location along roadway 14, controller 34 may analyze the received beams from one side (e.g., a left side) of machine 12 to determine actual locations of objects that are either marker 16 or roadway 14. Specifically, controller 34 may analyze data points defined by the received beams, and, based on characteristics of the data points, may separate the data points into first and second groups of consecutive points, the first and second groups representing marker 16 and roadway 14, respectively. An analysis may be performed on the first group of consecutive points defined by the received beams. Controller 34 may compute a first curve, which may be a generally straight line, that “best-fits” these points. Similarly, an analysis may be performed on the second group of consecutive points defined by the received beams. Controller 34 may compute a second curve, which may be a generally straight line, that “best-fits” these points. An intersection point of the first and second curves may be used to define the actual location of the bottom of marker 16 for that side (e.g., the left side) of machine 12 at that geographical location on roadway 14. Similarly, the actual location of the bottom of marker 16 may be determined for the other side (e.g., the right side) of machine 12 at that same geographical location on roadway 14. In accordance with the disclosure, a comparison of the actual locations of the bottoms of markers 16 on opposite sides of machine 12 may be used to determine the bank of roadway 14 at that geographical location.

As discussed above, machine 12 may determine its position on roadway 14, either as a result of measuring its direction and position relative to break 18 (which has a known geographical location) or through the use of locating device 32. Controller 34 may include means for monitoring, recording, storing, indexing, processing, and/or communicating the bank of roadway 14 and the geographical location of machine 12. This means may be the same means for monitoring, recording, storing, indexing, processing, and/or communicating the lateral distance between machine 12 and marker 16, or may be a different means. Controller 34 may also use the same means, or a different means, for autonomously controlling maneuvering of machine 12 in response to this information regarding the bank of roadway 14.

Specifically, controller 34 may store one or more bank maps (discussed below), each bank map storing maximum permissible or recommended speeds as a function of road banks and steering angles, or storing maximum permissible or recommended speeds as a function of road banks, steering angles, and speeds. Controller 34 may receive the actual steering angle of machine 12, such as by output from steering angle sensor 38, and use the bank map to identify the maximum permissible or recommended speeds of machine 12. Controller 34 may also compare the actual speed at which machine 12 is traveling down roadway 14, such as by output from speed sensor 36, to a maximum permissible speed of machine 12 on roadway 14 from the bank map. Based on a result of this comparison, controller 34 may respond in a number of different ways. For example, if the actual speed of machine 12 is about equal to the maximum permissible speed, controller 34 may not respond at all. However, if the actual speed of machine 12 is greater than the maximum permissible speed by a first threshold amount, controller 34 may warn the operator of machine 12 of imminent danger or recommend action by the operator, and/or autonomously control braking device 28 to slow or even stop travel of machine 12 on roadway 14. The warning or recommendation may be audible, visual, or a combination of both audible and visual stimulation, and may use indicating device 40. Further, if the actual speed of machine 12 is less than the maximum permissible speed by a second threshold amount, controller 34 may recommend to the operator that the speed of machine 12 be increased, or controller 34 may increase the speed of machine 12. This recommendation also may be audible, visual, or a combination of both, and indicating device 40 may be used. The second threshold amount may be the same as or different than the first threshold amount.

The one or more bank maps stored by controller 34 may include a number of different bank maps storing maximum permissible or recommended speeds as a function of road banks and steering angles. Similar to the factors discussed above with respect to selection of the grade map, the particular bank map used by controller 34 may be selected based on a variety of factors including one or more of a roadway condition, an environmental condition, a machine condition, an operator condition, and or other similar conditions. Similarly, the bank map used by controller 34 may be selected based on a potential severity associated with machine 12 contacting or crossing marker 16. In accordance with the above discussion, these factors may be set by the operator or may result from outputs of various sensors. In the alternative, the bank map may be selected by the operator of machine 12.

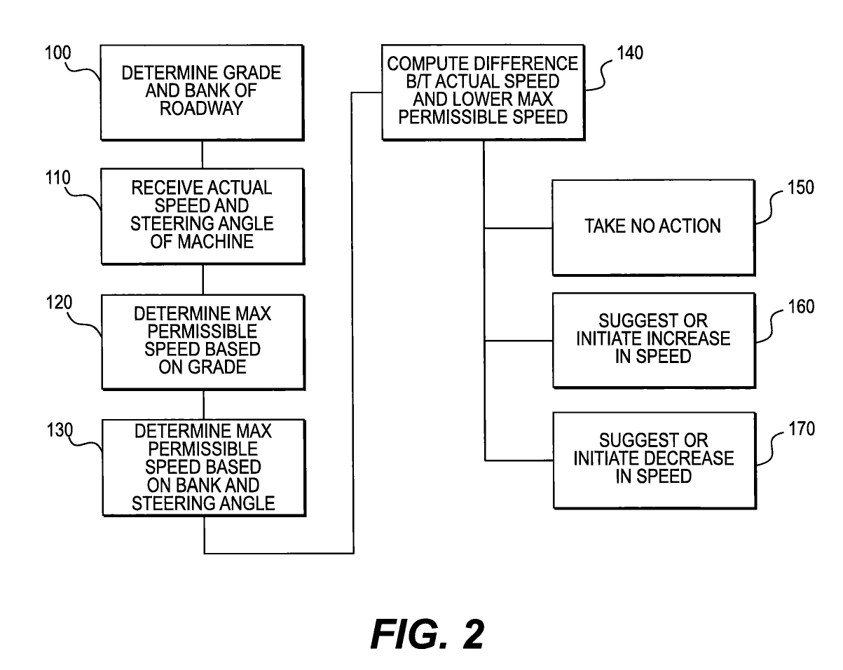

FIG. 2 illustrates an exemplary method performed by controller 34 during operation of machine 12. FIG. 2 will be described in more detail in the follow section to further illustrate the disclosed guidance system and its operation.

### INDUSTRIAL APPLICABILITY

The disclosed guidance system may be applicable to any mobile machine where lane keeping is important. The disclosed guidance system may provide warning and/or autonomous maneuvering in an effort to prevent lane deviation. And, the disclosed system may be adaptable and account for varying roadway conditions, environmental conditions, machine conditions, operator conditions, and other similar conditions when providing the warning or autonomously maneuvering the machine. Operation of guidance system 24 will now be described.

As machine 12 travels along roadway 14, controller 34 may determine a grade of roadway 14 and a bank of roadway 14 (Step 100). This determination may be made continuously, periodically, or upon request by an operator. Controller 34 may also receive outputs from speed sensor 36, indicating the actual speed of machine 12 on roadway 14, and steering angle sensor 38, indicating the actual steering angle of machine 12 on roadway 14 (Step 110) Controller 34 may use the grade map to determine a first maximum permissible or recommended speed of machine 12 based on the determined grade of roadway 14 (Step 120), and may also use the bank map to determine a second maximum permissible or recommended speed of machine 12 based on the determined bank of roadway 14 and the actual steering angle of machine 12 (Step 130). Controller 34 may compute a difference between the actual speed of machine 12 on roadway 14 and the lower value of the first and second maximum permissible speeds (Step 140). If the computed difference is within a specified threshold, controller 34 may take no action (Step 150). If the computed difference exceeds the specified threshold, and the actual speed of machine 12 is less than the maximum permissible speed of machine 12 used in the comparison, controller 34 may suggest increasing the speed of machine 12, or may initiate an increase in the speed of machine 12 (Step 160). Conversely, if the difference exceeds the specified threshold, and the actual speed of machine 12 is greater than the maximum permissible speed of machine 12 used in the comparison, controller 34 may output a recommendation to decrease the speed of machine 12 or may initiate a decrease in the speed of machine 12, such as by autonomously operating braking device 28 to slow or even stop travel of machine 12 on roadway 14 (Step 170).

Several benefits may be provided by the disclosed guidance system. For example, the disclosed guidance system may accurately determine the actual grade and bank of the roadway, since the grade and bank may be based on generally the entire width of the roadway, as compared to known prior art systems that scan a relatively small area of the roadway and therefore may only sense a grade or a bank of that particular portion of the roadway. Further, the disclosed guidance system is relatively inexpensive, since the same scanning devices that sense the distance to the berm may be used to determine the grade and the bank of the roadway, and thus the complexity and costs associated with using other, specialized sensors is avoided.

One scanning device 30, or more than one scanning device 30, may be mounted on opposite sides of machine 12, for example, so that a grade and/or bank of roadway 14 may be determined for a current location of machine 12. Operation of machine 12 may be modified based on this grade and/or bank information at the current location. Alternately, one scanning device 30, or more than one scanning device 30, may be mounted adjacent or on a front of machine 12, for example, so that a grade and/or bank of roadway 14 may be determined down the road from machine 12 (i.e., at a location other than the current location of machine 12). Future operation of machine 12 may be modified based on this grade and/or bank information as machine 12 approaches the scanned location, and/or current operation of machine 12 may be modified in anticipation of machine 12 driving on the scanned location.

It will be apparent to those skilled in the art that various modifications and variations can be made to the guidance system of the present disclosure. Other embodiments of the method and system will be apparent to those skilled in the art from consideration of the specification and practice of the guidance system disclosed herein. It is intended that the specification and examples be considered as exemplary only, with a true scope of the disclosure being indicated by the following claims and their equivalents.

What is claimed is:

1. A method of determining a grade of a roadway bordered by a marker including a bottom that contacts the roadway, with a machine traveling on the roadway, the method comprising:
locating, with a scanning device mounted on the machine, a first point indicative of the bottom of the marker at a first geographical location along the roadway;
locating, with the scanning device, a second point indicative of the bottom of the marker at a second geographical location along the roadway; and
comparing the locations of the first point and the second point to determine the grade of the roadway.

2. The method of claim 1, wherein locating the first point includes scanning the marker and the roadway with the scanning device, and analyzing a result of the scanning to determine the first point indicative of the bottom of the marker.

3. The method of claim 1, wherein locating the first point includes scanning the marker and the roadway with a plurality of scanning beams emitted by the scanning device, and analyzing a result of the scanning to determine the first point indicative of the bottom of the marker.

4. The method of claim 1, wherein the first point and the second point are located substantially simultaneously.

5. The method of claim 1, wherein the first point and the second point are located at different times.

6. The method of claim 1, wherein the scanning device is further configured to output a signal indicative of a distance between the marker and the machine.

7. The method of claim 1, further including:
outputting a signal, with the scanning device, which suggests or causes a change in operation of the machine based on the comparison.

8. The method of claim 1, wherein the marker is an earthen berm,
wherein locating the first point includes scanning the earthen berm and the roadway with a plurality of scanning beams emitted by the scanning device, and analyzing a result of the scanning to determine the first point indicative of the bottom of the earthen berm, and
wherein locating the second point includes scanning the earthen berm and the roadway with a plurality of scanning beams emitted by the scanning device, and analyzing a result of the scanning to determine the second point indicative of the bottom of the earthen berm.

9. A method of determining a bank of a roadway bordered on a first side by a first marker including a bottom that contacts the roadway and bordered on a second side by a second marker including a bottom that contacts the roadway, with a machine traveling on the roadway, the method comprising:
locating, with a first scanning device mounted on one of a left side and a right side of the machine, a first point indicative of the bottom of the first marker at a geographical location along the roadway;
locating, with a second scanning device mounted on the other one of the right side and the left side of the machine, a second point indicative of the bottom of the second marker at the same geographical location; and
comparing the locations of the first point and the second point to determine the bank of the roadway.

10. The method of claim 9, wherein locating the first point includes scanning the first marker and the roadway with the first scanning device, and analyzing a result of the scanning to determine the first point indicative of the bottom of the first marker.

11. The method of claim 9, wherein locating the first point includes scanning the first marker and the roadway with a plurality of scanning beams emitted by the first scanning device, and analyzing a result of the scanning to determine the first point indicative of the bottom of the first marker.

12. The method of claim 9, wherein the first point and the second point are located substantially simultaneously.

13. The method of claim 9, wherein the first point and the second point are located at different times.

14. The method of claim 9, wherein the first and second scanning devices are configured to output signals indicative of distances between the first and second marker and the machine.

15. The method of claim 9, wherein the first and second markers are first and second earthen berms, respectively,
wherein locating the first point includes scanning the first earthen berm and the roadway with a plurality of scanning beams emitted by the first scanning device, and analyzing a result of the scanning to determine the first point indicative of the bottom of the first earthen berm, and
wherein locating the second point includes scanning the second earthen berm and the roadway with a plurality of scanning beams emitted by the second scanning device, and analyzing a result of the scanning to determine the second point indicative of the bottom of the second earthen berm.

16. A method of controlling travel of a machine on a roadway bordered by an earthen berm including a bottom that contacts the roadway, the method comprising:
determining at least one of a grade and a bank of the roadway by sensing the bottom of the earthen berm with at least one sensing device mounted on the machine;
determining, with a controller, a maximum speed for the machine to travel on the roadway, based on the determined grade or bank of the roadway;
comparing, with the controller, an actual speed at which the machine is traveling on the roadway with the determined maximum speed; and
outputting, with the controller, a signal based on the comparison which suggests or causes a change in operation of the machine.

17. The method of claim 16, wherein determining at least one of the grade and the bank includes determining both the grade and the bank of the roadway.

18. The method of claim 17, wherein determining the maximum speed for the machine to travel on the roadway includes determining a first maximum speed based on the determined grade of the roadway, and determining a second maximum speed based on the determined bank of the roadway, and
wherein comparing the actual speed includes comparing the actual speed at which the machine is traveling with the lower value of the first maximum speed and the second maximum speed.

19. The method of claim 18, wherein outputting the signal includes outputting either a warning signal or an autonomous control signal when the actual speed exceeds the lower value of the first and second maximum speed by a threshold amount.

20. The method of claim 18, wherein outputting the signal includes outputting a signal recommending an increase in the speed of the machine when the actual speed is less than the lower value of the first or second maximum speeds, and a difference between the actual speed and the lower value of the first and second maximum speeds is greater than a threshold amount.
